(19) United States
(12) Patent Application Publication
(10) Pub. No.: US 2006/0010981 A1
(43) Pub. Date: Jan. 19, 2006

(54) Vibration type pressure sensor

(75) Inventors: Nishikawa Tadashi, Tokyo (JP); Arai Yuji, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/180,277

(22) Filed: Jul. 12, 2005

(30) Foreign Application Priority Data
Jul. 16, 2004 (JP) 2004-209290

(51) Int. Cl. G01L 11/00

(52) U.S. Cl. 73/702

(57) ABSTRACT

A resonant type pressure sensor has a diaphragm to which a measuring pressure is to be applied, and a vibrating beam which is embedded on the diaphragm, and orthogonal supporting portions which are provided at sides of both ends of the vibrating beam, wherein one end of each orthogonal supporting portion is substantially perpendicular to the vibrating beam, and another end of each orthogonal supporting portion is substantially perpendicular to a face of the diaphragm.

### CROSS-REFERENCE TO RELATED APPLICATIONS

This application is based upon and claims the benefit of priority from the prior Japanese Patent Applications No. 2004-209290, filed on Jul. 16, 2004, the entire contents of which are incorporated herein by reference.

### BACKGROUND OF THE INVENTION

1. Field of the Invention

The present invention relates to a resonant type pressure sensor in which compression strain due to a static pressure is improved and the static pressure effect is improved.

2. Description of the Related Art

JP-UM-A-63-63737 (page 2, FIG. 3) is referred to as a related art of a resonant type pressure sensor.

FIG. 12 is a sectional view of main portions of a related pressure sensor. Such a pressure sensor is disclosed in, for example, JP-UM-A-63-63737.

In the figure, the reference number 1 is a semiconductor chip.

In this case, silicon is used.

The reference numeral 2 is a dint which is formed in the semiconductor chip 1 and which fabricates a sensing diaphragm forming a pressure sensor.

The reference numeral 4 is a semiconductor pressure sensing element embedded in the strain sensitive portion 3 of the semiconductor chip 1.

In this case, a silicon resonator is used.

The reference numeral 5 is a supporting base plate in which one face is connected to the semiconductor chip 1, and which is made of an insulating material. A pressure introducing chamber 6 is comprised of the dint 2 and a piecing hole 7.

In this case, Pyrex (registered trademark) glass is used, and the whole face of the glass is directly bonded to the semiconductor chip 1.

In this case, the semiconductor chip 1 is anodically bonded to the supporting base plate 5.

The reference numeral 7 is the piecing hole which is formed in the glass supporting substrate 5, and which introduces the lower pressure PL to the pressure introducing chamber 6.

In the above-described configuration, when a lower pressure PL is introduced into the pressure introducing chamber 6 and a higher pressure PH is applied from the other side to the diaphragm 3, the diaphragm 3 is displaced by a pressure difference of (the higher pressure PH)—(the lower pressure PL).

This displacement is electrically transformed by using the semiconductor pressure sensing element 4, so that an electric signal output corresponding to the pressure difference is obtained.

However, such an apparatus have the following problems.

When a static pressure is applied, the difference between the Young's modulus of the semiconductor chip 1 and the supporting base plate 5 causes compression strain which is larger than that of the semiconductor chip 1 itself. The larger compression strain is applied to the semiconductor pressure sensing element 4.

In this case, the Young's modulus of the semiconductor chip 1 made of silicon is E=135 GPa, and that of the supporting base plate 5 made of Pyrex (registered trademark) glass is E=80 GPa. This means that the supporting base plate 5 is larger in bulk compressibility than the semiconductor chip 1.

Therefore, compression strain which is larger (approximately 1.5 to 2 times) than that of the semiconductor chip 1 itself made of silicon is applied to the semiconductor pressure sensing element 4.

As a result, the operational strain range of the semiconductor pressure sensing element 4 is limited, and the normal operation range and withstanding pressure performance of the semiconductor pressure sensor are restricted.

At present, therefore, the sensor sensitivity is restricted (the performance is lowered), or that the normal operation range is also restricted (the withstanding pressure performance is lowered) is inevitably taken.

### SUMMARY OF THE INVENTION

The object of the invention is to provide a resonant type pressure sensor in which the withstanding pressure performance can be improved, the sensitivity can be enhanced, the range ability is widened, and the output ripple can be reduced.

The invention provides a resonant type pressure sensor having: a diaphragm to which a measuring pressure is to be applied; a vibrating beam which is embedded on the diaphragm; and orthogonal supporting portions which are provided at sides of both ends of the vibrating beam, wherein one end of each orthogonal supporting portion is substantially perpendicular to the vibrating beam, and another end of each orthogonal supporting portion is substantially perpendicular to a face of the diaphragm.

In the resonant type pressure sensor, a correction value of a static pressure effect is adjusted by adjusting mounting location of the supporting portions.

According to the resonant type pressure sensor, since compression strain of the vibrating beam due to static pressure strain is relaxed or reduced by applying of tension strain, the operation range of the vibrating beam can be widened.

Therefore, the withstanding pressure performance can be improved, and the sensitivity of the vibrating beam can be enhanced. As a result, a resonant type pressure sensor having the wide range ability and the small output ripple can be achieved.

Further, since the correction value of a static pressure effect can be adjusted by adjusting a mounting position of the supporting portions, it is possible to provide a resonant type pressure sensor in which the withstanding pressure performance can be further improved.

### BRIEF DESCRIPTION OF THE DRAWINGS

FIG. 1 is a diagram illustrating the configuration of main portions of an embodiment of the invention;

FIG. 2 is a plan view of FIG. 1;

FIG. 3 is a diagram illustrating the configuration of main portions of FIG. 1;

FIG. 4 is a diagram illustrating fabrication process of FIG. 1;

FIG. 5 is a diagram illustrating fabrication process of FIG. 1;

FIG. 6 is a diagram illustrating fabrication process of FIG. 1;

FIG. 7 is a diagram illustrating fabrication process of FIG. 1;

FIG. 8 is a diagram illustrating fabrication process of FIG. 1;

FIG. 9 is a diagram illustrating fabrication process of FIG. 1;

FIG. 10 is a diagram illustrating fabrication process of FIG. 1;

FIG. 11 is a diagram illustrating fabrication process of FIG. 1; and

FIG. 12 is a diagram illustrating the configuration of main portions of a related pressure sensor.

### DETAILED DESCRIPTION OF THE PREFERRED EMBODIMENTS

An embodiment of the invention will be described in detail with reference to the accompanying drawings.

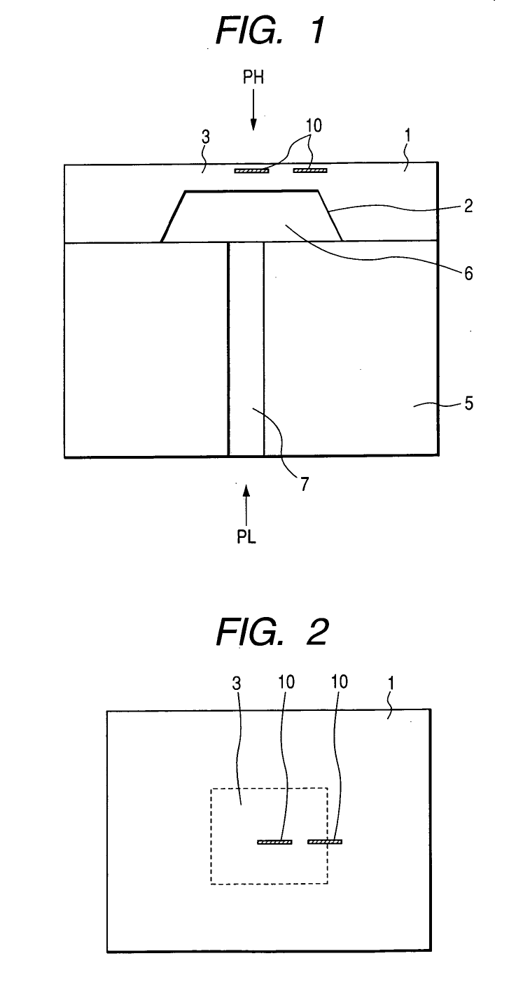

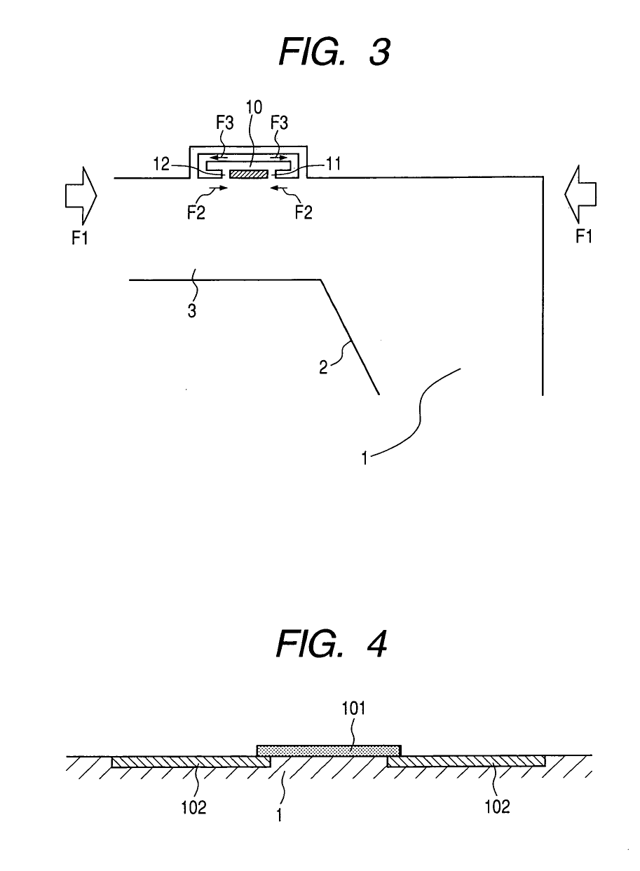

FIG. 1 is a diagram illustrating the configuration of main portions of an embodiment of the invention, FIG. 2 is a plan view of FIG. 1, and FIG. 3 is a diagram illustrating the configuration of main portions of FIG. 1.

First and second orthogonal supporting portions 11, 12 are fabricated at sides of both ends of a vibrating beam 10. One ends of the first and second orthogonal supporting portions 11, 12 are substantially perpendicular to the ends of the vibrating beam 10, and other ends of the first and second orthogonal supporting portions 11, 12 are substantially perpendicular to a face of the diaphragm 3.

The mounting positions (attachment position) of the supporting portions 11, 12 are adjustable, so that the correction value of a static pressure effect can be adjusted.

In the above-described configuration, when a static pressure F1 is applied, compression strain F2 is generated in the fixed ends of the vibrating beam 10, so that tension strains F3 in the directions of the arrows ← and → are produced in the portion of the vibrating beam 10.

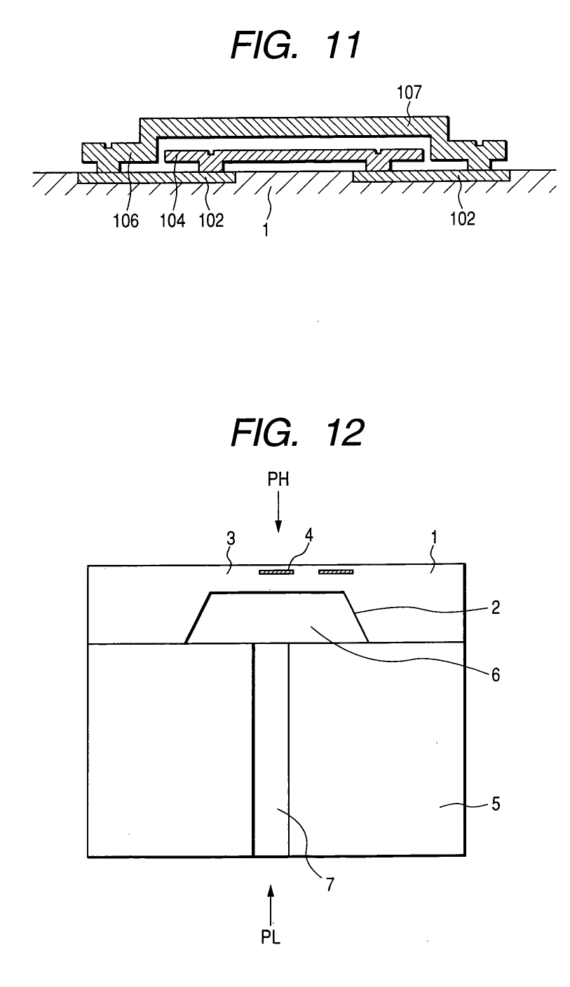

The thus configured apparatus is fabricated as shown in FIGS. 4 to 11.

Referring to FIG. 4, a silicon dioxide film 101 is formed in the surface of the semiconductor chip 1, and a portion corresponding to a gap below the vibrating beam 10 is then formed by using a photolithography process.

Electrode lead portions 102 are formed by P⁺ diffusion process.

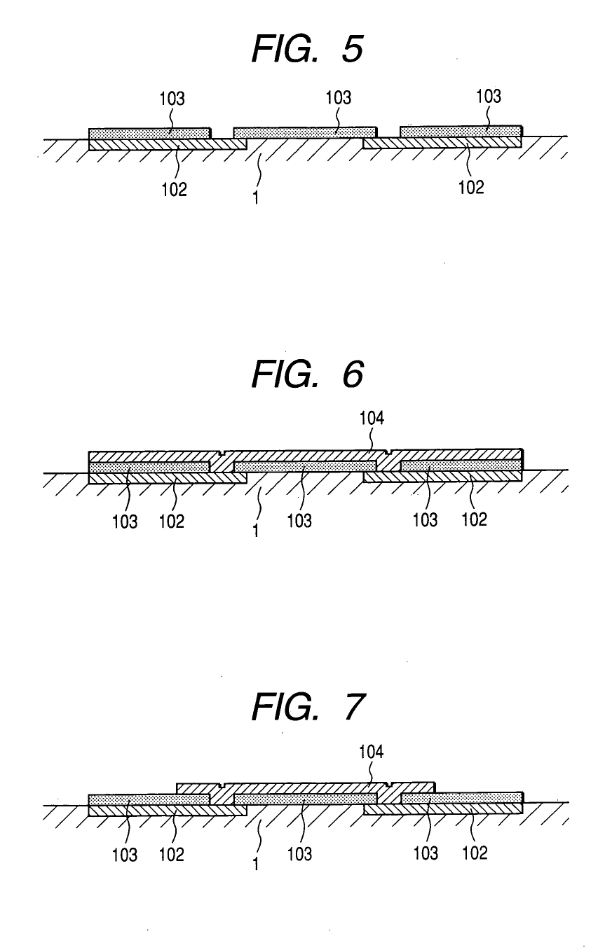

Referring to FIG. 5, after the silicon dioxide film 101 is removed away, another silicon dioxide film 103 is formed, and holes for the first and second supporting portions 11, 12 are then formed by a photolithography process.

Referring to FIG. 6, a polysilicon film 104 corresponding to the portion of the vibrating beam 10 is grown. Thereafter, P⁺⁺ diffusion using boron B is implemented.

Referring to FIG. 7, the portion of the vibrating beam 10 is formed by an RIE etching process.

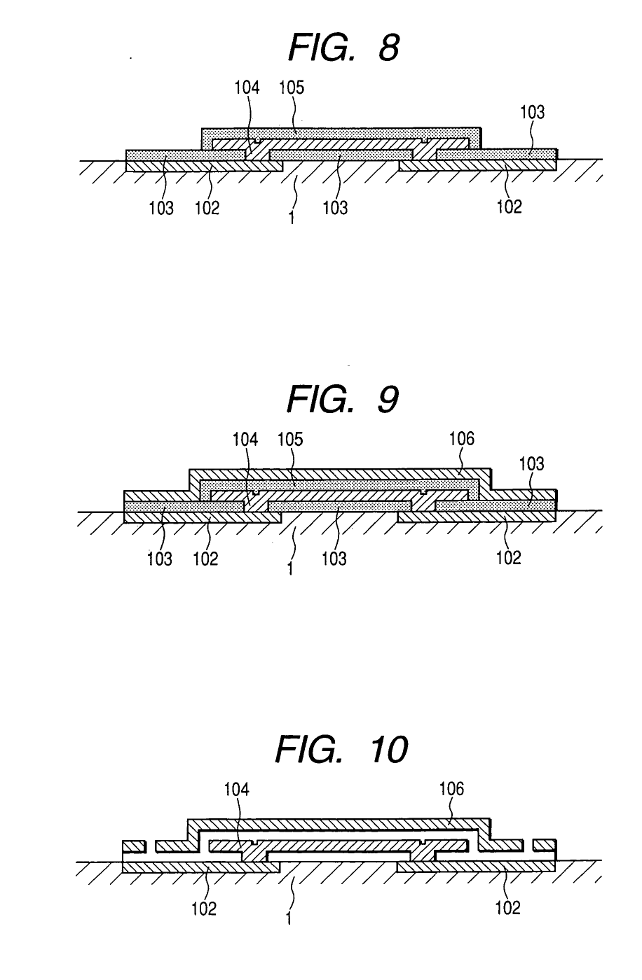

Referring to FIG. 8, a silicon dioxide film 105 is grown by CVD, and then a polysilicon film 106 is formed.

Referring to FIG. 9, channels for etching of the silicon dioxide films 103, 105 are formed in the polysilicon film 106, and then the silicon dioxide films 103, 105 are removed away.

Referring to FIG. 10, a polysilicon film 107 is grown, and vacuum sealing is then completed.

As a result, the compression strain F2 of the vibrating beam 10 due to the static pressure F1 is relaxed or reduced by applying the tension strains F3, and hence the operation range of the vibrating beam 10 can be widened.

Therefore, the withstanding pressure performance can be improved, and the sensitivity of the vibrating beam 10 can be enhanced. As a result, it is possible to obtain a resonant type pressure sensor having the wide range ability is widened, and the small output ripple.

The above description shows only a specific preferred embodiment for the purposes of illustration and exemplification of the invention.

Therefore, the invention is not limited to the embodiment, and includes further changes and modifications without departing the spirit of the invention.

What is claimed is:

1. A resonant type pressure sensor comprising:
a diaphragm to which a measuring pressure is to be applied;
a vibrating beam which is embedded on the diaphragm; and
orthogonal supporting portions which are provided at sides of both ends of the vibrating beam, wherein one end of each orthogonal supporting portion is substantially perpendicular to the vibrating beam, and another end of each orthogonal supporting portion is substantially perpendicular to a face of the diaphragm.

2. The resonant type pressure sensor according to claim 1,
wherein a correction value of a static pressure effect is adjusted by adjusting mounting location of the supporting portions.
